(19) United States
(12) Patent Application Publication
(10) Pub. No.: US 2017/0206430 A1
(43) Pub. Date: Jul. 20, 2017

(54) METHOD AND SYSTEM FOR OBJECT DETECTION

(71) Applicants: Pablo ABAD, Schweinfurt (DE); Stephan KRAUSS, Kaiserslautern (DE); Jan HIRZEL, Kaiserslautern (DE); Didier STRICKER, Kaiserslautern (DE)

(72) Inventors: Pablo ABAD, Schweinfurt (DE); Stephan KRAUSS, Kaiserslautern (DE); Jan HIRZEL, Kaiserslautern (DE); Didier STRICKER, Kaiserslautern (DE)

(21) Appl. No.: 15/000,454

(22) Filed: Jan. 19, 2016

(51) Int. Cl. G06K 9/46; H04N 5/232

(52) U.S. Cl. CPC G06K 9/4671; H04N 5/232

(57) ABSTRACT

A method, system and computer program product for detecting an object within a frame, the method comprising: receiving calibration parameters of a camera; obtaining four or more salient points of an object model, wherein a plane containing the salient points is at an arbitrary position relatively to a frame view of the camera; determining a projection of each of the at least four salient feature points onto the frame view of the camera, thus determining a quadrilateral in frame coordinates; determining a transformation for transforming the quadrilateral into a rectangle having edges parallel to edges of frames captured by the camera; receiving at least a part of the frame captured by the camera; applying the transformation to the at least part of the frame to obtain a rectangular search area having edges parallel to edges of the frame; and detecting an object within the rectangular search area.

### TECHNICAL FIELD

The present disclosure relates to detecting objects in captured images.

### BACKGROUND

Many locations are constantly or intermittently captured by stills or video cameras capturing frames of the environment, for purposes including but not limited to security.

In some applications, it may be required to identify objects in the captured frames. Problems of recognizing objects have been addressed in the conventional art and various techniques have been developed to provide solutions, for example:

Fidler et al. in “3D Object Detection and Viewpoint Estimation with a Deformable 3D Cuboid Model” published in Advances in Neural Information Processing Systems 25 (NIPS 2012) addresses the problem of category-level 3D object detection. Given a monocular image, their aim is to localize the objects in 3D by enclosing them with tight oriented 3D bounding boxes. An approach is proposed that extends the well-acclaimed deformable part-based model to reason in 3D. Their model represents an object class as a deformable 3D cuboid composed of faces and parts, which are both allowed to deform with respect to their anchors on the 3D box. The appearance of each face is modelled in fronto-parallel coordinates, thus effectively factoring out the appearance variation induced by viewpoint. The model reasons about face visibility patterns called aspects. The cuboid model is trained jointly and discriminatively and weights are shared across all aspects to attain efficiency. Inference then entails sliding and rotating the box in 3D and scoring object hypotheses. While for inference the search space is discretized, the variables are continuous in the model. The effectiveness of the approach is demonstrated in indoor and outdoor scenarios.

Xiang et al. in “Estimating the Aspect Layout of Object Categories” published in CVPR 2012, focuses on i) detecting objects; ii) identifying their 3D poses; and iii) characterizing the geometrical and topological properties of the objects in terms of their aspect configurations in 3D. Such characterization is called an object's aspect layout. A model is proposed for solving these problems in a joint fashion from a single image for object categories. The model is constructed upon a framework based on conditional random fields with maximal margin parameter estimation.

Hedau et al. in “Thinking Inside the Box: Using Appearance Models and Context Based on Room Geometry” published in ECCV 2010 show that a geometric representation of an object occurring in indoor scenes, along with rich scene structure can be used to produce a detector for that object in a single image. Using perspective cues from the global scene geometry, a 3D based object detector is developed. This detector is competitive with an image based detector built using other methods; however, combining the two produces an improved detector, because it unifies contextual and geometric information. A probabilistic model is then used that explicitly uses constraints imposed by spatial layout—the locations of walls and floor in the image, to refine the 3D object estimates. An existing approach is used to compute spatial layout, and use constraints such as objects supported by floor and cannot stick through the walls. The resulting detector has improved accuracy when compared to the other 2D detectors, and gives a 3D interpretation of the location of the object, derived from a 2D image.

The references cited above teach background information that may be applicable to the presently disclosed subject matter. Therefore the full contents of these publications are incorporated by reference herein where appropriate for appropriate teachings of additional or alternative details, features and/or technical background.

### BRIEF SUMMARY

One aspect of the disclosed subject matter relates to a computer-implemented method for detecting an object within a frame, comprising: receiving calibration parameters of a camera; obtaining four or more salient points of an object model, wherein a plane containing the salient points is at an arbitrary position relatively to a frame view of the camera; determining a projection of each of the salient feature points onto the frame view of the camera, thus determining a quadrilateral in frame coordinates; determining a transformation for transforming the quadrilateral into a rectangle having edges parallel to edges of frames captured by the camera; receiving at least a part of the frame captured by the camera; applying the transformation to the at least part of the frame to obtain a rectangular search area having edges parallel to edges of the frame; and detecting an object within the rectangular search area. The method may further comprise receiving the object model. Within the method, the object model optionally comprises at least size, position and orientation of an object. Within the method, the object model is optionally a three dimensional bounding box. Within the method, the salient points are optionally corner points of a side of the object model. Within the method, the object model is optionally obtained by measurement or by estimation. Within the method, determining the projection and determining the transformation is optionally performed offline. Within the method, the transformation is optionally expressed as a transformation matrix. The method is optionally repeated for a multiplicity of objects within the frame. Within the method, detecting an object within the rectangular search area is optionally performed by a detector adapted for detecting the object at a predetermined position or orientation. Within the method, the calibration parameters optionally comprise one or more intrinsic parameters selected from the group consisting of: focal length, sensor size, horizontal or vertical field of view, center of projection, and at least one distortion parameter. Within the method, the calibration parameters optionally comprise one or more extrinsic parameter selected from the group consisting of: position and rotation. Within the method, one or more calibration parameters are received from the camera. Within the method, all calibration parameters are received from the camera.

Another aspect of the disclosed subject matter relates to a computerized system for detecting an object within a frame, the system comprising a processor configured to: receiving calibration parameters of a camera; obtaining four or more salient points of an object model, wherein a plane containing the salient points is at an arbitrary position relatively to a frame view of the camera; determining a projection of each of the salient feature points onto the frame view of the camera, thus determining a quadrilateral in frame coordinates; determining a transformation for transforming the quadrilateral into a rectangle having edges parallel to edges of frames captured by the camera; receiving at least a part of the frame captured by the camera; applying the transformation to the at least part of the frame to obtain a rectangular search area having edges parallel to edges of the frame; and detecting an object within the rectangular search area. Within the system, the processor is optionally further configured to receiving the object model, and wherein the object model comprises at least size, position and orientation of an object or wherein the object model is a three dimensional bounding box. Within the system, the calibration parameters optionally comprise one or more intrinsic parameter selected from the group consisting of: focal length, sensor size, horizontal or vertical field of view, center of projection, and at least one distortion parameter, and the calibration parameters optionally comprise one or more extrinsic parameter selected from the group consisting of: position and rotation. Within the system, at least one calibration parameter is optionally received from the camera. Within the system, all calibration parameters are optionally received from the camera.

Yet another aspect of the disclosed subject matter relates to a computer program product comprising a computer readable storage medium retaining program instructions, which program instructions when read by a processor, cause the processor to perform a method comprising: receiving calibration parameters of a camera; obtaining four or more salient points of an object model, wherein a plane containing the salient points is at an arbitrary position relatively to a frame view of the camera; determining a projection of each of the salient feature points onto the frame view of the camera, thus determining a quadrilateral in frame coordinates; determining a transformation for transforming the quadrilateral into a rectangle having edges parallel to edges of frames captured by the camera; receiving at least a part of the frame captured by the camera; applying the transformation to the at least part of the frame to obtain a rectangular search area having edges parallel to edges of the frame; and detecting an object within the rectangular search area.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows an illustration of an exemplary environment in which the disclosed subject matter may be used, in accordance with some exemplary embodiments of the disclosed subject matter;

FIG. 2 shows a flowchart of steps in a method for locating an object within a frame, in accordance with some exemplary embodiments of the disclosed subject matter; and

FIG. 3 shows a flowchart of steps in a method for locating an object within a frame, in accordance with some exemplary embodiments of the disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “representing”, “comparing”, “generating”, “assessing”, “matching”, “updating”, “determining” or the like, refer to the action(s) and/or process(es) of a computer that manipulate and/or transform data into other data, said data represented as physical, such as electronic, quantities and/or said data representing the physical objects. The term “computer” should be expansively construed to cover any kind of electronic device with data processing capabilities including, by way of non-limiting example, a digital camera or video camera, or any computing platform disclosed in the present application.

The operations in accordance with the teachings herein may be performed by a computer specially constructed for the desired purposes or by a general-purpose computer specially configured for the desired purpose by a computer program stored in a computer readable storage medium.

It is to be understood that the term “non-transitory memory” is used herein to exclude transitory, propagating signals, but to include, otherwise, any volatile or non-volatile computer memory technology suitable to the presently disclosed subject matter.

The term camera used in this patent specification should be expansively construed to cover any kind of a capturing device providing digital images, such as a digital camera, a digital video camera, an Infrared camera, a digitizer for digitizing analog images, or the like.

The detection of objects in images and videos is a problem that encounters multiple types of obstacles derived from the complexities of the real world environment. Such complexities, and in particular when capturing outdoor scenes, may include but are not limited to changing lighting conditions, movement of the captured objects, camera position changes due to user intended action, winds, gravitation, occlusions, image artifacts, and more. Some known techniques for object detection, for example Histogram of Gradients (HOG) features, are designed to cope with light changes, and with limited pose changes of the object relatively to the pose of the object in a training set upon which the detection engine was trained. Since these techniques are based on 2D image information derived from image patches, they provide non-satisfactory results when the object position changes relatively to the training set.

In some embodiments, detection is carried out under the assumption that the object position is the same as in the training set, thus often providing results of low quality. In other embodiments, detection with two or more different position hypotheses is attempted, which consumes significant time or computing resources.

In some applications, such as traffic monitoring, it may be required to detect objects in real time or at least in high speed and with high precision rate, although the object position may vary, for example the object may move along an axis perpendicular to the frame of the camera thus changing its size, move in other directions, rotate or any combination thereof.

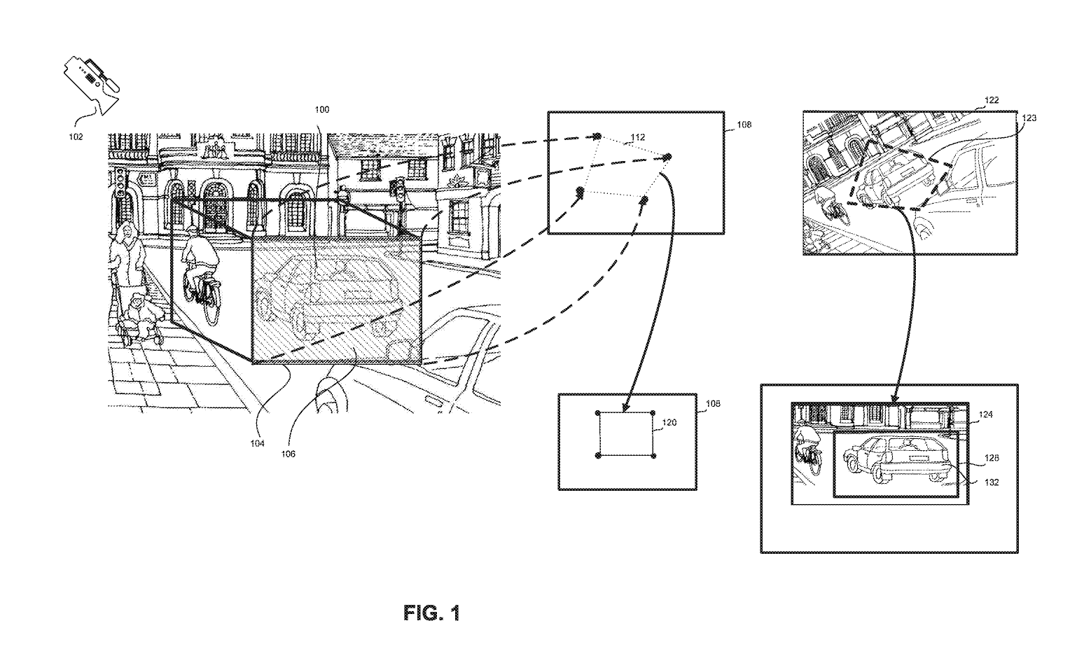

Referring now to FIG. 1, showing an illustration of an exemplary environment in which the disclosed subject matter may be used.

An object 100, such as a car, is present at a scene. It may be required to identify object 100 in a frame captured by a camera 102 overlooking and capturing the scene.

In some embodiments of the disclosed subject matter, an object model may be received which may describe the position within the real world, at a given time, of an object to be detected within a frame captured by a camera. The object model may include location, orientation and size. In some embodiments, the object model may be described by a box 104 bounding the object.

The position of salient points, such as three or more corners of a face 106 of the bounding box may be determined in world coordinates. If three corners of one rectangular face are provided, the fourth corner of the same face may be obtained by geometrical computations.

The calibration parameters of camera 102 may be received, for example from the camera itself, or from a computing platform in communication with the camera. The calibration parameters may include orientation and position of the camera relatively to a coordinate system of the captured environment, lens parameters, focal length zoom, or the like, at the time when object 100 is at the determined position.

Using the calibration parameters of camera 102, the salient points, for example four corners of face 106 may be projected onto the plane of frame view 108 of camera 102, thus forming a quadrilateral 112. The points are known to be on the same plan since so are the points forming face 106 of object box 104.

A transformation may then be determined which may transform quadrilateral 112 into rectangle 120 whose sides are parallel to the edges of frame view 108. The transformation may be expressed as a 3*3 transformation matrix.

The transformation may then be applied to a part 123 of a captured frame 122, wherein part 123 corresponds to quadrilateral 112, thus obtaining rectangle 128 corresponding to rectangle 120, wherein face 106 appears in rectangle 128 as a rectangle having sides parallel to the frame edges. In some embodiments, the transformation may be applied to part 123 with some margins, thus obtaining area 124, in order to allow for slight mismatches. Area 124 is also a rectangle having its sides parallel to the frame view. Alternatively, rectangle 124 may be determined from rectangle 128 with some margins.

Rectangle 128 or rectangle 124 may then be provided to an object detector, which may detect car 132 corresponding to real object 100. Thus, the distortion introduced by the different angle between the camera and object face plane is removed, and although the face of the bounding box of the object is originally at an arbitrary position relatively to frame view 108, the object detector only needs to search for the object in a predetermined orientation and in a rectangle having sides parallel to edges of the frames, and not in any arbitrary angle, thus reducing computational complexity and saving significant computing resources such as time, memory, processing power or the like.

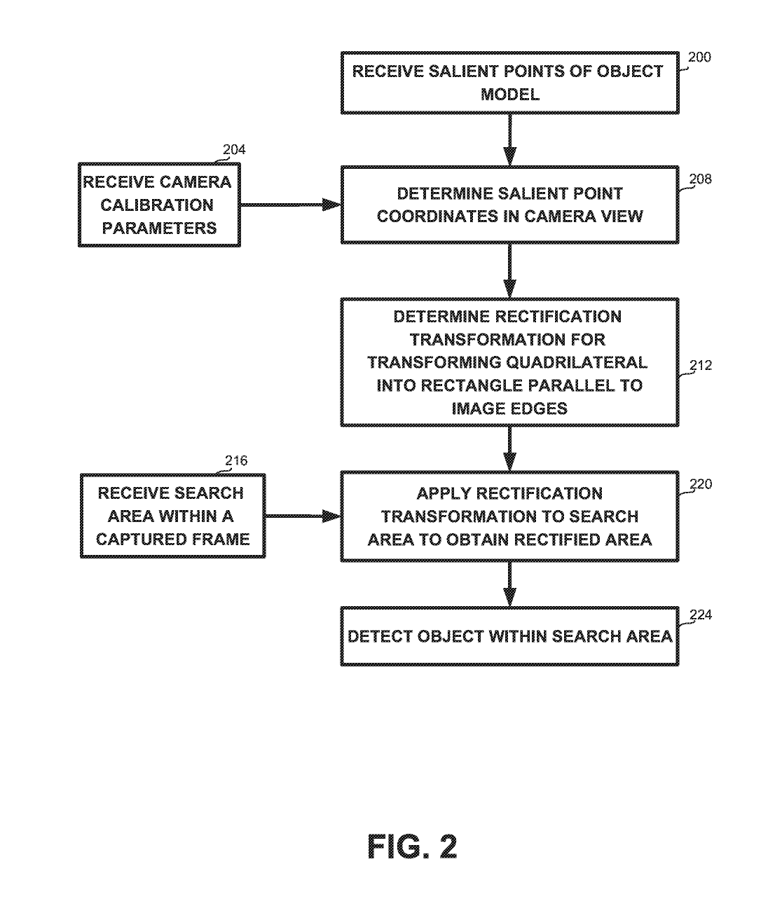

Referring now to FIG. 2, showing a flowchart of steps in a method for locating an object within a frame, in accordance with some exemplary embodiments of the disclosed subject matter.

On step 200 salient points of an object model may be received. In some embodiments, the full object model may be received and the salient points, such as three or more corners of a face of the object may be extracted therefrom. An object model may comprise the dimensions, position, and orientation of the object, and may be received as a bounding box surrounding the object.

The object model, or the salient points, may be received, for example, from an image taken by another camera having partial overlap with the camera in which images it is required to detect the object, from estimating the location of the object based on previous known location and relationship between the wo locations, from analyzing motion of the objects, from one or more sensors, or the like.

On step 204, calibration parameters of the camera may be received, including for example its location, orientation expressed for example by a vector perpendicular to the sensor, focal length, zoom, or the like. The parameters may include all extrinsic and intrinsic parameters of the camera, such that a point or a face of the object model may be projected to obtain its 2D coordinates in the coordinated of the camera frame view. It will be appreciated that the calibration parameters may be received for every frame processed, every predetermined period of time, every predetermined number of frames, a combination thereof, or the like.

On step 208, the coordinates of the salient points on the camera frame view may be determined, based upon their locations in real world coordinates, and the camera calibration parameters. Projecting four corners of a rectangular face forms a quadrilateral on the camera frame view in frame coordinates. The quadrilateral is generally not a square, a rectangle, or of any other specific shape, but may have arbitrary sides and angles.

On step 212 a rectification transformation may be determined, which transforms the quadrilateral formed by the projection of the object face the camera view, into a rectangle having its sides parallel to the frame edges. The transformation may include translation, rotation, scaling, or any combination thereof. The transformation may be expressed as a matrix or in any other manner.

On step 216, a search area of a captured frame may be received, wherein the search area corresponding to the quadrilateral determined on step 208, or to an area comprising the quadrilateral with some margins. The search area thus narrows down the area in which the object is to be searched for. The search area is comprised within the frame view of the camera, and attempts to take into account location uncertainties stemming for example from imprecise measurements, inaccuracies in the camera calibration, or the like.

On step 220, the rectification transformation may be applied to the search area within the captured frame, to obtain a rectified area. Applying the transformation transforms at least a part of the image in which the object is to be detected, such that the distortion introduced by the different angle between the camera and object face plane is removed. Thus, a single transformation, although it may be expressed as a series of transformations, removes all orientation and affine distortions, leaving only scale uncertainty at the worst case.

On step 224 an object may be detected within the rectified area. The object may be detected using any detection tool or method, including any detection tool or method configured for searching objects positioned or oriented in specific direction, such as in parallel to a side the frame. In some embodiments, the detection tool or method may tolerate uncertainty of the scaling of the object, and may detect the object regardless of its size, as long as it is comprised within the search area. Such uncertainty may result from the frame view being at unknown distance from the camera.

By ensuring that the object is positioned as required by eliminating rotation, affine and three dimensional effects, a detection tool may avoid trial and error in detecting objects positioned at various angles, which may waste significant processing time and other resources. In some embodiments, a detection tool may be used which operates as the detection engine detailed in U.S. patent application Ser. No. 14/807,622 filed Jul. 23, 2015 hereby incorporated by reference in its entirety and for all purposes, or in a similar manner.

It will be appreciated that the method may be repeated for a multiplicity of objects within the frame. However, the camera calibration parameters may be obtained just once and used when detecting further objects.

It will be appreciated that in some embodiments, a set of rectification transformations may be determined and stored for predetermined stored quadrilaterals. Then, if a quadrilateral received during processing is close enough to one of the stored quadrilaterals, the associated transformation may be used, thus performing a significant part of the processing offline and providing faster results in runtime.

It is noted that the teachings of the presently disclosed subject matter are not bound by the flow chart illustrated in FIG. 2, rather the illustrated operations can occur out of the illustrated order. For example, receiving steps 200, 204 and 216 can be executed substantially concurrently or in any order. It is also noted that whilst the flow chart is described with reference to certain elements, this is by no means binding, and the operations can be performed by elements other than those described herein.

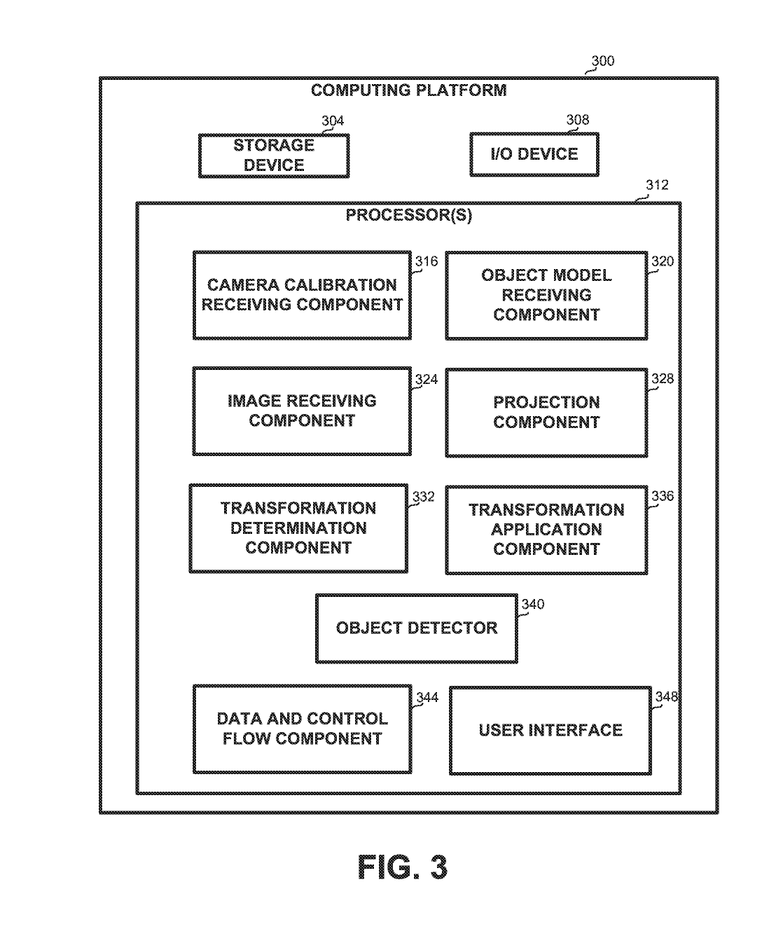

Referring now to FIG. 3, showing a block diagram of a system for detecting objects within frames.

The system may be implemented as a computing platform 300, such as a server, a desktop computer, a laptop computer, a processor embedded within a video capture device, or the like. Computing platform 300 may also be implemented as two or more computing platforms, wherein, for example, some processing steps are performed by the camera capturing images, while other processing steps are performed on one or more other computing platforms, such as a server receiving data or images from the camera directly or indirectly.

In some exemplary embodiments, computing platform 300 may comprise a storage device 304. Storage device 304 may comprise one or more of the following: a hard disk drive, a Flash disk, a Random Access Memory (RAM), a memory chip, or the like. In some exemplary embodiments, storage device 304 may retain program code operative to cause processor 312 detailed below to perform acts associated with any of the components executed by computing platform 300, such as the steps indicated on FIG. 2 above.

In some exemplary embodiments of the disclosed subject matter, computing platform 300 may comprise an Input/Output (I/O) device 308 such as a display, a pointing device, a keyboard, a touch screen, or the like. I/O device 308 may be utilized to provide output to or receive input from a user.

Computing platform 300 may comprise a processor 312. Processor 312 may comprise any one or more of the following processing units, such as but not limited to: a Central Processing Unit (CPU), a microprocessor, an electronic circuit, an Integrated Circuit (IC), a Central Processor (CP), a processor embedded within a camera, or the like. In other embodiments, processor 312 may be a graphic processing unit. In further embodiments, processor 312 may be a processing unit embedded in a video capture device. Processor 312 may be utilized to perform computations required by the system or any of its subcomponents. Processor 312 may comprise one or more processing units in direct or indirect communication. Processor 312 may be configured to execute several functional modules in accordance with computer-readable instructions implemented on a non-transitory computer usable medium. Such functional modules are referred to hereinafter as comprised in the processor.

The modules, also referred to as components as detailed below, may be implemented as one or more sets of interrelated computer instructions, loaded to and executed by, for example, processor 312 or by another processor. The components may be arranged as one or more executable files, dynamic libraries, static libraries, methods, functions, services, or the like, programmed in any programming language and under any computing environment.

Processor 312 may comprise camera calibration receiving component 316, for receiving camera calibration data, directly from the camera or from another computing platform, via any communication channel and in any required format.

In some exemplary embodiments, the calibration parameters may comprise extrinsic and intrinsic parameters. The extrinsic parameters may comprise position, expressed for example in 3 dimensional coordinates; or rotation, expressed for example as yaw, pitch and roll. The intrinsic parameters may comprise focal length, sensor size, horizontal or vertical field of view, or center of projection. It will be appreciated that focal length and sensor size combined can provide substantially the same information as the vertical and horizontal fields of view combined. Thus, in some embodiments, it may be sufficient to receive one of these combinations. Optionally, the intrinsic parameters may comprise one or more lens distortion parameters, for example radial distortions may be modelled by 3 parameters.

In some embodiments, the camera may comprise a position sensor which can determine the camera location, for example a Global Positioning System (GPS). Additionally or alternatively, the camera may comprise one or more gyroscopes for determining its rotation. This way the camera can obtain and provide its extrinsic calibration parameters.

In some embodiments, the camera may determine its intrinsic parameters, for example current focal length if the focal length is variable, or its focal length if a fixed focal length is used, wherein the information can be stored in the camera. The size of the sensor chip in X and Y dimensions, which are known constants for a specific chip or a specific camera may also be stored in the camera.

The lens distortion parameters can be measured once the camera has been manufactured, and may be stored in the camera as well.

Thus, in some embodiments, the complete set of calibration parameters, comprising intrinsic and extrinsic parameters may be available in the camera, and may be made available to another computing platform from the camera. In such implementation, camera calibration receiving component 316 may receive the calibration parameters from the camera, or if camera calibration receiving component 316 is implemented within the camera, it may simply access the relevant memory locations. In this implementation, whenever a new camera is used and it is required to analyze the output frames, the calibration parameters may immediately be available, which makes a system using such cameras more adjustable and easier to install and maintain. In other embodiments, one or more calibration parameters may be received from another system, form a user, or the like.

Processor 312 may comprise object model receiving component 320, for receiving data related to the location and orientation of an object. The data may relate to one or more points of the object, may comprise a 3D bounding box of the object, may indicate size, location and orientation or the object, or the like.

Processor 312 may comprise image receiving component 324, for receiving captured frames, directly from the camera or via another computing platform, via any communication channel and in any required format. In some embodiments, only parts of the frames may be received. In further embodiments, different parts of one or more frames may be received at different resolutions.

Processor 312 may comprise projection component 328 for projecting one or more points associated with the object model on a frame view, the frame view determined from the camera calibration parameters.

Processor 312 may comprise transformation determination component 332 for determining a transformation from four points creating a planer quadrilateral on a frame view, to a rectangular area having its sides parallel to sides of the comprising frame.

Processor 312 may comprise transformation application component 336 for applying the transformation to an area of a captured frame corresponding to the quadrilateral, to obtain a rectangular area with sides parallel to the edges of the frame, such that an object detection tool may recognize the object therein, once its orientation is known and corresponds to an orientation in which it may be identified.

Processor 312 may comprise object detector 340, for detecting an object within a search area, once the orientation of the area is known. One exemplary embodiment of object detector 340 is disclosed in U.S. patent application Ser. No. 14/807,622 filed Jul. 23, 2015.

Processor 312 may comprise data and control flow component 344 for controlling the activation of the various components, providing the required input to each component and receiving the required output from each component.

Processor 312 may comprise user interface 348 for receiving input from a user, such as indication of an object to be detected in frames, and to provide data to a user, such as displaying the captured frames with the detected objects. For example, an identified object may have a frame drawn around it.

It is noted that the teachings of the presently disclosed subject matter are not bound by the system described with reference to FIG. 3. Equivalent and/or modified functionality can be consolidated or divided in another manner and can be implemented in any appropriate combination of software, firmware and hardware and executed on one or more suitable devices.

For example, in one possible implementation, no processing or computation is performed by the camera. In another possible implementation, the camera performs all processing, excluding the user interface, and may use special purpose computing hardware embedded within the camera. However, additional implementations are also possible, for example wherein the camera may do the image rectification and transmit rectified images to the computing platform. However, such implementation may require that the object location and size, for example the object model, is provided to the camera beforehand, which may raise synchronization issues. For example, the object model, and particularly the object location, is valid for a specific point in time, but may be received by the camera only after the frame has already been transmitted, which may then require additional computations

The method and system may be used as a standalone system, or as a component for implementing a feature in a system such as a video camera, or in a device intended for a specific purpose.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Embodiments of the presently disclosed subject matter are not described with reference to any particular programming language. It will be appreciated that a variety of programming languages may be used to implement the teachings of the presently disclosed subject matter as described herein. Thus, computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on a user's computer, partly on a user's computer, as a stand-alone software package, partly on a user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. It will also be noted that each block of the block diagrams and/or flowchart illustration may be performed by a multiplicity of interconnected components, or two or more blocks may be performed as a single block or step.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the appended claims.

What is claimed is:

1. A computer-implemented method for detecting an object within a frame, comprising:
receiving calibration parameters of a camera;
obtaining at least four salient points of an object model, wherein a plane containing the at least four salient points is at an arbitrary position relatively to a frame view of the camera;
determining a projection of each of the at least four salient feature points onto the frame view of the camera, thus determining a quadrilateral in frame coordinates;
determining a transformation for transforming the quadrilateral into a rectangle having edges parallel to edges of frames captured by the camera;
receiving at least a part of the frame captured by the camera;
applying the transformation to the at least part of the frame to obtain a rectangular search area having edges parallel to edges of the frame; and
detecting an object within the rectangular search area.

2. The method of claim 1, further comprising receiving the object model.

3. The method of claim 2, wherein the object model comprises at least size, position and orientation of an object.

4. The method of claim 2, wherein the object model is a three dimensional bounding box.

5. The method of claim 1, wherein the at least four salient points are corner points of a side of the object model.

6. The method of claim 2, wherein the object model is obtained by measurement or by estimation.

7. The method of claim 1, wherein determining the projection and determining the transformation is performed offline.

8. The method of claim 1, wherein the transformation is expressed as a transformation matrix.

9. The method of claim 1, wherein the method is repeated for a multiplicity of objects within the frame.

10. The method of claim 1, wherein detecting an object within the rectangular search area is performed by a detector adapted for detecting the object at a predetermined position or orientation.

11. The method of claim 1, wherein the calibration parameters comprise at least one intrinsic parameter selected from the group consisting of: focal length, sensor size, horizontal or vertical field of view, center of projection, and at least one distortion parameter.

12. The method of claim 1, wherein the calibration parameters comprise at least one extrinsic parameter selected from the group consisting of: position and rotation.

13. The method of claim 1, wherein at least one calibration parameter is received from the camera.

14. The method of claim 1, wherein all calibration parameters are received from the camera.

15. A computerized system for detecting an object within a frame, the system comprising a processor configured to:
receiving calibration parameters of a camera;
obtaining at least four salient points of an object model, wherein a plane containing the at least four salient points is at an arbitrary position relatively to a frame view of the camera;
determining a projection of each of the at least four salient feature points onto the frame view of the camera, thus determining a quadrilateral in frame coordinates;
determining a transformation for transforming the quadrilateral into a rectangle having edges parallel to edges of frames captured by the camera;
receiving at least a part of the frame captured by the camera;
applying the transformation to the at least part of the frame to obtain a rectangular search area having edges parallel to edges of the frame; and
detecting an object within the rectangular search area.

16. The system of claim 15, wherein the processor is further configured to receiving the object model, and wherein the object model comprises at least size, position and orientation of an object or wherein the object model is a three dimensional bounding box.

17. The system of claim 15, wherein the calibration parameters comprise at least one intrinsic parameter selected from the group consisting of: focal length, sensor size, horizontal or vertical field of view, center of projection, and at least one distortion parameter, and wherein the calibration parameters comprise at least one extrinsic parameter selected from the group consisting of: position and rotation.

18. The system of claim 15, wherein at least one calibration parameter is received from the camera.

19. The system of claim 15, wherein all calibration parameters are received from the camera.

20. A computer program product comprising a computer readable storage medium retaining program instructions, which program instructions when read by a processor, cause the processor to perform a method comprising:
receiving calibration parameters of a camera;
obtaining at least four salient points of an object model, wherein a plane containing the at least four salient points is at an arbitrary position relatively to a frame view of the camera;
determining a projection of each of the at least four salient feature points onto the frame view of the camera, thus determining a quadrilateral in frame coordinates;
determining a transformation for transforming the quadrilateral into a rectangle having edges parallel to edges of frames captured by the camera;
receiving at least a part of the frame captured by the camera;
applying the transformation to the at least part of the frame to obtain a rectangular search area having edges parallel to edges of the frame; and
detecting an object within the rectangular search area.
